(19) United States
(12) Patent Application Publication
(10) Pub. No.: US 2002/0192427 A1
(43) Pub. Date: Dec. 19, 2002

(54) Bonding structure for synthetic resin parts

(75) Inventors: Toru Misawa, Odawara-shi (JP); Kazuyori Kito, Odawara-shi (JP); Tomonori Ikuma, Wako-shi (JP); Kazuyoshi Sato, Wako-shi (JP)

Correspondence Address: MacPherson Kwok Chen & Heid LLP, Suite 195E, 2001 Gateway Place, San Jose, CA, 95110, US

(73) Assignee: MIKUNI CORPORATION, TOKYO (JP)

(21) Appl. No.: 10/146,359

(22) Filed: May 14, 2002

(30) Foreign Application Priority Data
May 15, 2001 (JP) 2001-145292

(51) Int. Cl. B32B 7/04

(52) U.S. Cl. 428/119; 428/133; 428/139

(57) ABSTRACT

A bonding structure for synthetic resin parts that can improve bonding strength at the bonding through heat, and is not influenced by the change in ambient temperature after bonding. The bonding structure for synthetic resin parts according to the present invention comprises: a cylindrical projection formed on at least one part of two synthetic resin parts that are to be bonded with each other, the cylindrical projection to be bonded to the other part such that a closed space is formed between the cylindrical projection and the other part; and at least one opening communicating inside and outside of the closed space with each other.

### BACKGROUND OF THE INVENTION

1. Field of the Invention

The present invention relates to a bonding structure for synthetic resin parts, and more particularly, to a bonding structure forming a closed space at a bonded portion.

2. Description of the Related Art

FIG. 7 shows a conventional bonding structure for synthetic resin parts. Parts 1, 2 are cylindrically shaped. In order to bind the parts 1, 2 with each other, a bottom face 1a of the part 1 and a top face 2a of the part 2 may directly be bonded. In such a case, that is, when two faces are bonded with each other, some areas on the faces cannot be bonded, which makes it impossible to secure desired bonding strength.

Therefore, a cylindrical projection 2b for bonding is formed on the part 2, and a top face of the cylindrical projection 2b is bonded to the bottom face 1a of the part 1. With this method, the two parts 1, 2 are bonded nearly between a line and a face, which allows overall contact portions to be bonded to stably secure the desired bonding strength.

FIGS. 8A and 8B are a perspective view and a longitudinal cross-sectional view respectively of the parts 1,2 that are bonded with each other. As illustrated, the melted cylindrical projection 2b through heating is pressed to the bottom face 1a of the part 1 to bond the parts 1, 2 with each other. Hot plate bonding, spin bonding, ultrasonic bonding, and vibration boding are examples of the above-mentioned bonding method. Bonding with bonding agent is used for a method in which parts to be bonded are not heated.

When the bonding is completed, as illustrated in FIG. 8B, a space 3, which is enclosed by the cylindrical projection 2b and the parts 1, 2, is formed. The space 3 is closed and is isolated from outside, so that air is shut in the space 3.

When the part 1, 2 are heated and bonded through hot plate bonding, spin bonding, ultrasonic bonding, or vibration boding for instance, the air in the space 3 expands due to heat generated when the part 1, 2 melt at the bonding, which unpreferably decreases adhesive strength at the bonding. Further, regardless of the heat at the bonding, when environment after the bonding changes and the air in the space 3 repeatedly expands and shrinks, tensile stress and compressive stress are repeatedly applied to bonded faces. As a result, there is a fear of reduced bonding strength due to fatigue due to the repeated stress.

### SUMMARY OF THE INVENTION

The present invention has been made to solve the above problems and to provide a bonding structure for synthetic resin parts that can improve bonding strength at the bonding through heat, and is not influenced by the changes in ambient temperature after bonding.

To accomplish the above objective, a bonding structure for synthetic resin parts according to the present invention comprises: a cylindrical projection formed on at least one part of two synthetic resin parts that are to be bonded with each other, the cylindrical projection to be bonded to the other part such that a closed space is formed between the cylindrical projection and the other part; and at least one opening communicating inside and outside of the closed space with each other.

The opening may be a hole drilled on one of the cylindrical projection and a portion other than the cylindrical projection, and the opening can be a notch extending from a bonded face side of the cylindrical projection toward a root thereof, and the notch can reach to the root of the cylindrical projection.

The bonding structure for synthetic resin parts described above may be a portion of a bonding structure for synthetic resin parts, and the portion is to be a corner of the bonding structure.

### BRIEF DESCRIPTION OF THE DRAWINGS

The present invention will be more apparent from the ensuring description with reference to the accompanying drawings wherein:

FIGS. 1A and 1B show a bonding structure for synthetic resin parts according to the first embodiment of the present invention, wherein FIG. 1A is a longitudinally cross-sectional view of a condition that the synthetic resin parts are bonded, and FIG. 1B is a top view of a lower part;

FIG. 2 is a longitudinally cross-sectional view of a bonding structure for synthetic resin parts according to the second embodiment of the present invention;

FIGS. 3A and 3B are perspective views of lower synthetic resin parts to be bonded through bonding structures for synthetic resin parts according to the third and forth embodiments of the present invention respectively;

FIG. 4 is a perspective view of a primary portion of a bonding structure for synthetic resin parts according to the fifth embodiment of the present invention;

FIG. 5 is a cross-sectional view of a bonded synthetic resin parts through a bonding structure according to the present invention;

FIG. 6 shows a condition that an intake manifold is mounted to a multiple cylinder engine;

FIG. 7 shows a conventional bonding structure for synthetic resin parts; and

FIGS. 8A and 8B are a perspective view and a longitudinal cross-sectional view respectively of bonded synthetic resin parts through the bonding structure shown in FIG. 7.

### DETAILED DESCRIPTION OF PREFERRED EMBODIMENTS

The bonding structure for synthetic resin parts according to the present invention will be described in detail with reference to the accompanying drawings.

FIG. 1 shows a bonding structure for synthetic resin parts according to the first embodiment of the present invention, in which a plurality of synthetic resin parts, which are used for an intake manifold made of synthetic resin as an intake system for an engine for instance, are bonded by vibration bonding. A part 1 of them is the same as the conventional one. Another part 12 is provided with a projection 12a for bonding at the top face thereof. Although the conventional projection 2a for bonding is cylindrical, the projection 12a is provided with a notch 12b and is C-shaped.

When the part 12 with the projection 12a is bonded to the bottom face of the part 1, a space 13 is not closed since inside and outside of the space 13 are communicated with each other through the notch 12b. With this construction, when the projection 12a is heated and is bonded to the bottom face of the part 1, the air in the space 13 is heated, but the pressure in the space 13 does not increase, so that adhesive strength at the bonding is not decreased.

Further, even if the ambient temperature changes, that is, it becomes higher or lower, the pressure in the space 13 is maintained constant as same as the outside pressure, which allows a stress not to be applied to the bonded portion. As a result, the decrease of the bonding strength due to repeated fatigue in the prior art is completely eliminated.

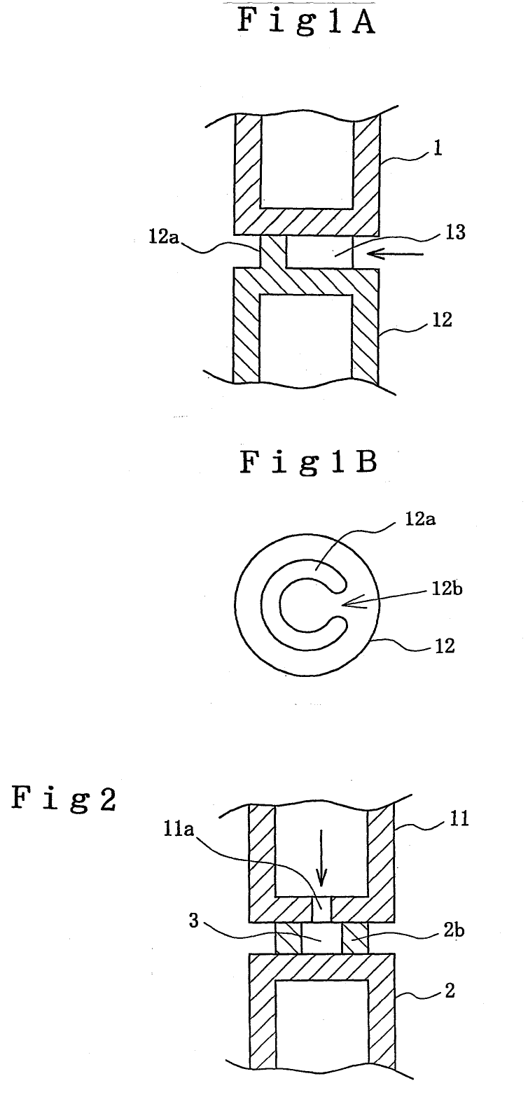

FIG. 2 is a longitudinally cross-sectional view of a bonding structure for synthetic resin parts according to the second embodiment of the present invention. In this embodiment, a part 2 is the same as the conventional one. Another synthetic resin part 11 is drilled to form a hole 11a, which communicates inside and outside of the space 3 with each other at the bottom face thereof. With the hole 11a, inside and outside of the space 3 are communicated with each other to prevent pressure increase in the space 3 due to the heat at a melt bonding and pressure decrease in the space 3 due to the temperature decrease after the melt bonding. The hole 1a may be drilled on the part 2 or on the cylindrical projection 2b.

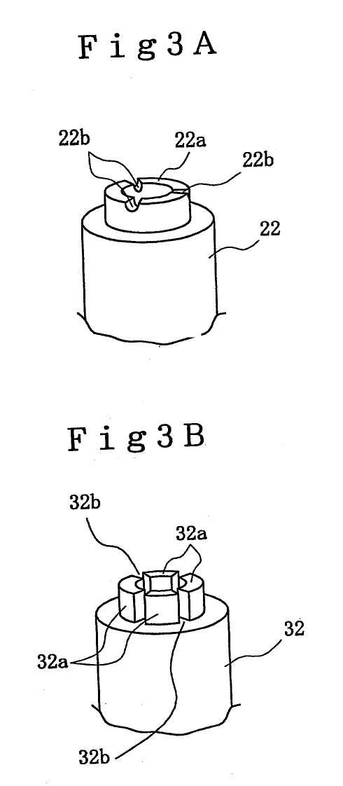

FIG. 3A shows a bonding structure for synthetic resin parts according to the third embodiment of the present invention, and is a perspective view of the lower synthetic resin part. On the top face of a synthetic resin part 22, a cylindrical projection 22a for bonding stands. The cylindrical projection 22a is provided with three notches 22b communicating inside and outside of the space 3 with each other, which extends from the bonding face side toward a root of the cylindrical projection 22a. The notch 22b extends to a middle portion of the cylindrical projection 22a. When the cylindrical projection 22a is bonded to the bottom face 1a of the part 1, the notches 22b remain as holes, which communicates inside and outside of the space 3 with each other, so that the pressure in the space 3 is maintained as the same as the outside pressure.

FIG. 3B shows a bonding structure for synthetic resin parts according to the forth embodiment of the present invention, and is a perspective view of the lower synthetic resin part. On the top face of a synthetic resin part 32, four projections 32a for bonding stand. The projections 32a are arranged in such a manner as to stand closely to each other and to form a cylindrical shape with the four projections 32a. In other words, in this embodiment, it may be possible to say that a cylindrical projection for bonding is formed and four notches 32b are formed so as to extend overall height from the bonding face of the projection 32a.

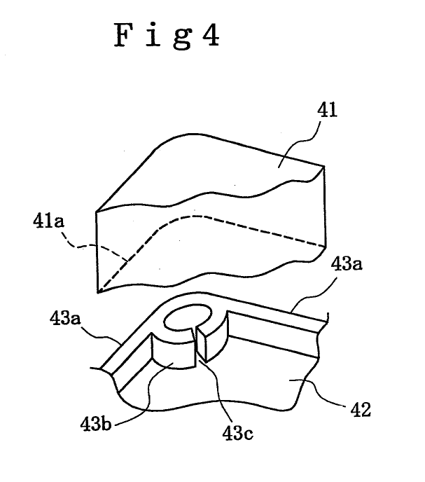

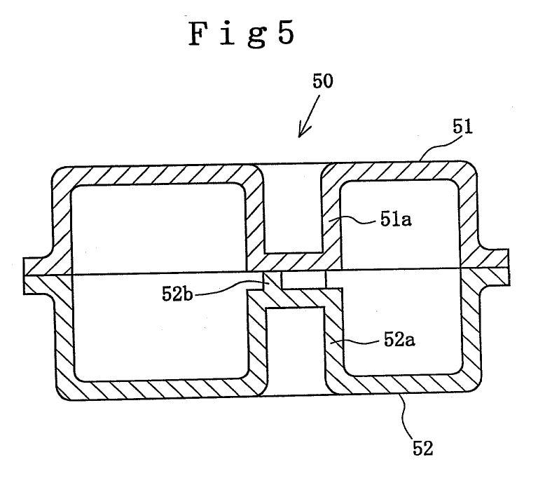

FIG. 4 is a perspective view of a primary portion of a bonding structure for synthetic resin parts according to the fifth embodiment of the present invention. The synthetic resin parts are cylindrically shaped in the embodiments shown in FIG. 1 to FIG. 3. In this embodiment, a synthetic resin part is formed to be round at a corner thereof, but shapes of other portions are optional. A lower face 41a of a synthetic resin part 41 is flat, and a lower synthetic resin part 42 is provided with a projection 43a for bonding along an edge thereof. The projection 43a is provided with a cylindrical projection 43b at a corner thereof, and a notch 43c is formed to the cylindrical projection 43b.

Without the cylindrical projection 43b at the corner, that is, with only the projection for bonding with round corner, there is a fear of decreased bonding strength at the corner. The cylindrical projection 43b in this embodiment is able to strengthen the bonding force at the corner.

In the embodiment shown in FIG. 4, when the two synthetic resin parts 41, 42 are bonded with each other through projection 43a 43b, a space enclosed by the projection 43b is formed between the synthetic resin part 41, 42. This space is provided with a notch 43c communicating inside and outside of the space with each other. As a result, the air in the space does not expand due to heat at the bonding nor shrink due to temperature decrease, which allows stable bonding force to be maintained.

When the projection 43a itself along the edge of the synthetic resin part 42 is formed to be cylindrical, a notch is suitably formed at any portion of the cylindrical projection 43b or a hole may be formed on the lower face 41a of the synthetic resin part 41.

FIG. 5 is a cross-sectional view of bonded synthetic resin parts according to the present invention. As the synthetic resin part, a relatively depressed box-shaped part 50 is illustrated. Bonding parts 51, 52, forms the box-shaped part 50 and the present invention is applied to supports 51a, 52a in the middle. At the top of the support 52a is formed a projection 52b for boding in the same manner as the projection 12a shown in FIG. 1 to bond the support 51a, 52a with each other and make the box-shaped part 50. With this bonding structure, resistance against tensile force added to the support 51a, 52a is strengthened.

In the above embodiments, although cylindrical projections for bonding are exemplified, the shape is not limited to round, but other shapes such as polygon including square and oval may be selected.

The bonding structure for synthetic resin parts according to the present invention is very suitable for bonding, through vibration, two injected synthetic resin parts to manufacture an intake manifold of a multiple cylinder engine for instance.

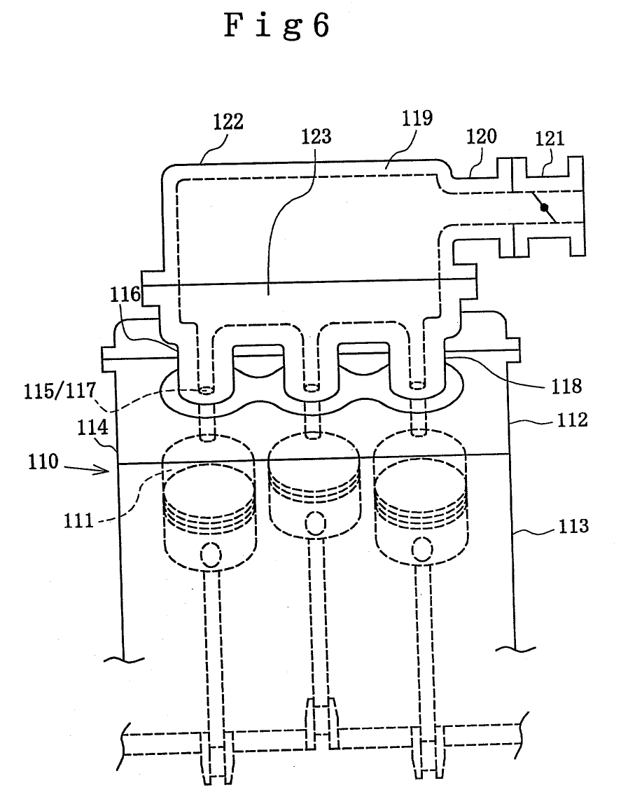

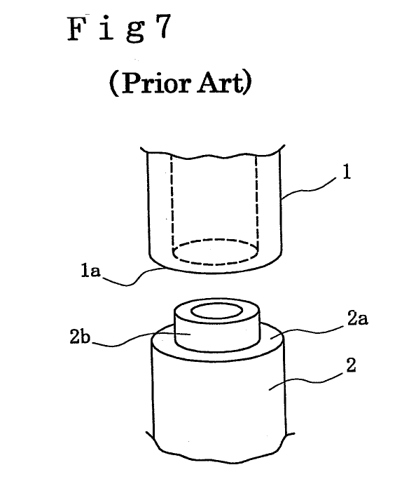

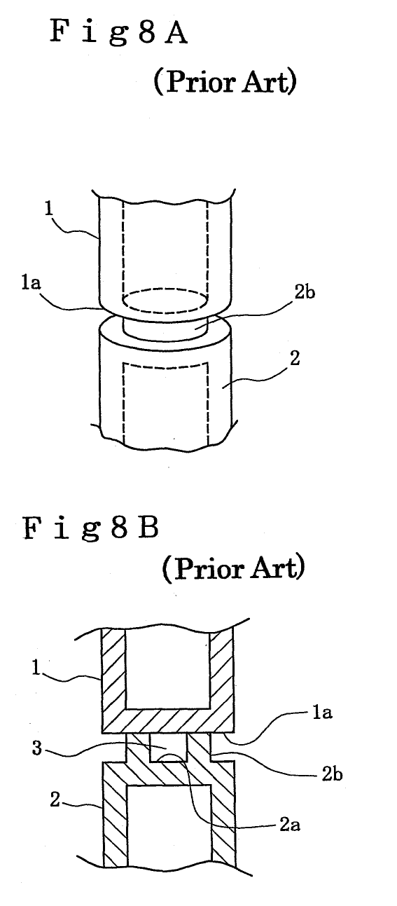

FIG. 6 shows a condition that an intake manifold is mounted to a multiple cylinder engine. As illustrated, the engine 110 is provided with a cylinder head 112 and a cylinder block 113 to form a combustion chamber 111. A plurality of intake passages 115 continuing the combustion chamber 111 are opened on an outer side face 114 of the cylinder head 112.

The engine 110 is further provided with an intake manifold 116 for feeding air for combustion to the combustion chamber 111. The intake manifold 116 is made of thermoplastic resin such as polypropylene for example, and is integrally formed with a plurality of pipes 118 with outlets 117 continuing the intake passages 115 of the cylinder head 112, chambers 119 commonly used for more than one pipe 118, and intake entrance 120 continuing to the chamber 119. At the intake entrance 120 is provided a throttle valve 121 for controlling intake air introduced to the engine 110, and opening and closing of the throttle valve 121 controls the quantity of the intake air.

The intake manifold 116 is almost divided into two pieces, and parts 122, 123 form inside space of the intake manifold 116.

Each part is suitably shaped and dimensioned for the requirement for the engine 110, and the chamber 119 is especially depressed box with sufficient volume in accordance with the supply to the combustion chamber 111, and is provided with a bonding face between the parts 122, 123.

By the way, the pressure in the intake manifold 116 becomes high when the engine 110 is driven and the pressure repeatedly changes, so that it is difficult to secure strength of the intake manifold 116 of which only outer circumferential faces of the part 122, 123 are bonded through vibration for instance. Therefore, it is preferable to form insular projections 2b, 12a, 22a, 32a in the middle of the outer circumferential faces of the parts 122, 123 or the projection 43b for bonding at a corner thereof to greatly improve the bonding strength between the part 122, 123, which provides sufficient bonding strength.

The intake manifold by this invention is available to adapt various types of engine including an outboard engine.

As described above, the bonding structure for synthetic resin parts according to the present invention comprises: a cylindrical projection formed on at least one part of two synthetic resin parts that are to be bonded with each other, the cylindrical projection to be bonded to the other part such that a closed space is formed between the cylindrical projection and the other part; and at least one opening communicating inside and outside of the closed space with each other, so that the decrease of the bonding strength due to heat at the bonding is prevented. Further, it is possible to prevent the reduction in the bonding strength due to repeated fatigue that is generated by repeated tensile and compressive stresses due to changes in ambient temperature after bonding.

The opening communicating inside and outside of a closed space with each other may be a hole drilled on the projection for bonding or other places, or a notch extending from a bonding face side of the projection for bonding toward a root thereof.

What is claimed is:

1. A bonding structure for synthetic resin parts comprising:
a cylindrical projection formed on at least one part of two synthetic resin parts that are to be bonded with each other, said cylindrical projection to be bonded to the other part such that a closed space is formed between said cylindrical projection and the other part; and
at least one opening communicating inside and outside of said closed space with each other.

2. The bonding structure for synthetic resin parts as claimed in claim 1, wherein said opening is a hole drilled on one of said cylindrical projection and a portion other than the cylindrical projection.

3. The bonding structure for synthetic resin parts as claimed in claim 1, wherein said opening is a notch extending from a bonded face side of said cylindrical projection toward a root thereof.

4. The bonding structure for synthetic resin parts as claimed in claim 3, wherein said notch reaches to said root of the cylindrical projection.

5. A bonding structure for synthetic resin parts characterized in that said bonding structure for synthetic resin parts claimed in claim 1 is provided to a portion thereof.

6. The bonding structure for synthetic resin parts as claimed in claim 5, wherein said portion is a corner of said bonding structure.
